(19) United States
(12) Patent Application Publication
(10) Pub. No.: US 2005/0121084 A1
(43) Pub. Date: Jun. 9, 2005

(54) Ball check valve

(75) Inventor: Bo Andersson, Cambridge, NY (US)

Correspondence Address: HESLIN ROTHENBERG FARLEY & MESITI PC, 5 COLUMBIA CIRCLE, ALBANY, NY, 12203, US

(73) Assignee: Danfoss Flomatic Corporation, Glens Falls, NY (US)

(21) Appl. No.: 10/727,732

(22) Filed: Dec. 4, 2003

(51) Int. Cl. F16K 15/04

(52) U.S. Cl. 137/533.11

(57) ABSTRACT

A ball check valve comprises a housing having walls defining a fluid inlet, a fluid outlet, and a chamber communicating with the inlet and with the outlet. The ball check valve includes a spherical hollow ball housing a plurality of spherical shock absorbing members that stabilize the spherical hollow ball during operation of the valve. The spherical hollow ball moves between a first, flow impeding position adjacent the inlet and a second position spaced from the inlet laterally of a fluid passageway in the chamber.

### TECHNICAL FIELD

This invention relates generally to valves, and more particularly, to a ball check valve with an improved design and construction.

### BACKGROUND OF THE INVENTION

Ball check valves are designed to permit the flow of fluid in one direction while preventing the fluid from flowing in the reverse direction. Conventional ball check valves utilize a ball formed by a metallic sphere with a coat of rubber or resin that is shiftable within a chamber of a housing between a flow impeding position adjacent a fluid inlet and a flow enabling position spaced from the fluid inlet. The ball has a diametric cross section larger than the diameter of the fluid inlet. The housing is provided with a seat for the ball adjacent the fluid inlet so that the ball and seat form a fluid resistant seal to substantially prevent fluid flow in an opposite direction from the chamber and back through the inlet.

One type of ball check valve has a housing within an internal fluid chamber having a generally “Y” configuration where the fluid inlet is located adjacent the juncture of two diverging passageways. One of the passageways functions as a guiding channel for movement of the ball, while the other passageway has a fluid outlet at its outermost end and serves as a fluid conduit between the inlet and outlet. The valve can be installed either horizontally or in a vertical flow up position in piping systems. The ball check valve having a “Y” configuration relies solely on the gravity of the ball for closing.

However, the balls used have a tendency to bounce around within the chamber, which causes the ball to leave its valve seat and cause water shocks. This bouncing or movement becomes more sever with higher flow rates or higher liquid flow velocities. During pump shut down, the ball closing can be so sever to cause noisy conditions through hydraulic shock waves known as water hammer. These forces can cause damage to the valve, piping and pumping equipment.

### SUMMARY OF THE INVENTION

Using a ball check valve in accordance with one or more principles of the present invention may alleviate the shortcomings of the prior art. The check valve of the present invention may be used in any type of hydraulic or other fluid flow lines such as, for example, water, sewage or waste water, agricultural water, dirty water, plant effluent, miscellaneous effluent, oil, or gas lines, wells, cisterns, pumping outfits or the like. Additionally, other uses may be made of the invention which falls within the scope of the claimed invention, but which is not specifically described below.

In one aspect of the invention, there is provided a ball check valve comprising a housing having walls defining a fluid inlet, a fluid outlet, and a chamber communicating with the inlet and with the outlet. The chamber includes a fluid passageway. The ball check valve also includes a spherical hollow ball in the chamber having a diametric cross-sectional area larger than the area of the inlet. The spherical hollow ball is movable between a first, flow impeding position adjacent the inlet and a second position spaced from the inlet to allow fluid to pass through the valve. A plurality of spherical shock absorbing members is contained within said spherical hollow ball. A coat of rubber of synthetic rubber may enclose the spherical ball.

Additional advantages are provided through the provision of a ball check valve using a hollow spherical ball partially filled with a plurality of smaller spherical energy absorbing members that interacts with the flow velocity passing through the valve and absorbs the physical shock forces subjected to the ball during closing or high velocity flow.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a cross-sectional view of a ball check valve in an open position, in accordance with the principles of the present invention;

FIG. 2 depicts a cross-sectional view of a ball check valve in a closed position in accordance with the principles of the present invention; and

FIG. 3 depicts a cross-sectional view of a spherical hollow ball having a plurality of shock absorbing members contained within in accordance with the principles of the present invention.

### BEST MODE FOR CARRYING OUT THE INVENTION

Presented herein is an improved ball check valve, which provides an enhanced ball. The enhanced ball includes a cavity filled with a plurality of smaller spherical energy or shock absorbing members.

Conventional ball check valves include a housing having walls that define a fluid inlet 102, a fluid outlet 104, and a chamber 106 communicating with inlet 102 and with outlet 106. Chamber 106 includes a fluid passageway between inlet 102 and outlet 104. The housing may include ball guiding structures or members or a guide part (not shown) for guiding a spherical ball along a path of travel between a first flow impeding position adjacent the inlet and a second position spaced from the inlet and laterally from the straight fluid passageway. An opening to the chamber is covered by a cap 108, which is fixed by, for example, a bolt and a nut. The opening is given a larger size than the ball and is used for inserting the ball into chamber 106.

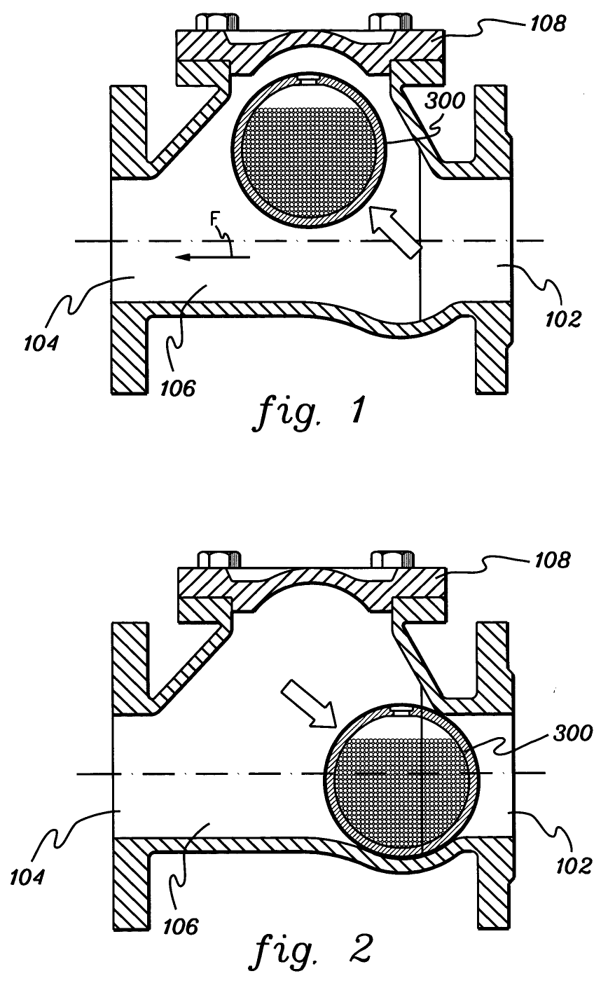

During operation, e.g. when flow is in the desired direction of arrow F, the ball is forced laterally from the straight flow passageway, allowing uninterrupted flow in the desired direction (e.g. as shown in FIG. 1). When the fluid flow is discontinued or tries to reverse itself, gravity and reverse fluid flow forces the ball, along ball guiding structures or members or guide part, adjacent inlet 102 for sealing engagement with inlet 102 (e.g. as shown in FIG. 2). Although the valve is shown in the horizontal position, it could be installed horizontally, or at any position therebetween, so long as the second position of the ball is at a higher elevation than the first position and the axis of the second position is not inclined below horizontal. Once the fluid generates in the desired direction, the ball moves from the first position and is guided to the second position.

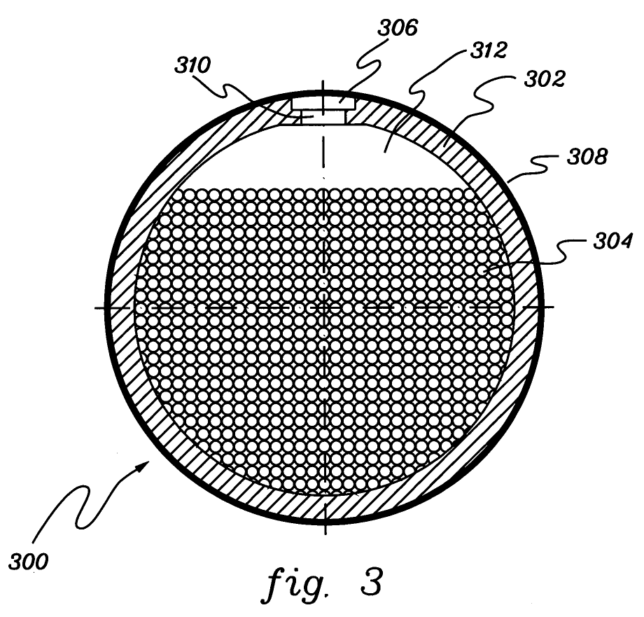

Referring now to FIGS. 1-3, a check valve constructed in accordance with the principles of the present invention is disclosed. In this embodiment, ball 300, as shown in FIG. 3, comprises a hollow sphere 302 defining an inside cavity with a plurality of smaller spherical energy absorbing members 304. The cavity of hollow sphere 302 is only partially filled with energy absorbing members 304 to allow movement of the members during operation and provide an energy absorption space 312 within the cavity.

Ball 300 includes a threaded access plug 306 allowing energy absorbing members 304 to be inserted through access port 310 into the cavity of hollow sphere 302. After members 304 are properly loaded within the cavity, access plug 306 is threaded in place and the top of the plug is ground off to the spherical counters of hollow ball 302. The outer surface of hollow ball 302 is then rubber coated or vulcanized 308 to protect access port 310.

In one embodiment, energy absorbing members 304 are small spheres or shot or ballast made from, for example, metal such as steel, lead/tungsten or other heavy material. The diameter of members may be, for example, one-eighth to one-quarter inch in diameter, although other sizes may be used. Sand filled balls may have similar energy absorbing characteristics. However, due to the lighter weight and physical characteristics (e.g. non-uniform shapes) of sand, sand is about three times less effective than spherical metal balls in regards to shock or energy absorbing capabilities. The shape of the members is also important. Spherical members 304 absorb sudden impacts by transmitting energy or shock through the radii of the members. Spherical members also provide less friction in relation to each other.

The key to a quiet efficient ball check valve operation is a ball check valve that uses a ball that seats quickly (e.g. moves to the first position) and does not leave the valve seat once the fluid flow stops. This is achieved with the present invention by loading a hollow ball 302 with a plurality of spherical members 304 having a weight that interacts with the flow velocity and absorbs the physical shock forces ball 300 is subjected to during closing and high velocity flow.

As the valve opens with the ball being pushed laterally from the straight fluid passageway by the flow velocity, conventional balls tend to bounce, e.g. from side to side and up and down, in the guide part. However, with the use of energy absorbing members 304 within ball 302 in accordance with the principles of the present invention, this bouncing is greatly reduced. Smaller energy absorbing members 304 always trail the movement of larger ball 302. As a result, the sum of the energy movement of all the smaller members together duels and slows down the movement of the larger ball. The resulting internal forces stabilize the movement of the ball during the normal flow condition and reduce the noise created by conventional ball valves.

During closing, the closing speed of ball 302 is assisted by the weight of smaller member 304 contained within its cavity. The closing of the ball valve is also more stable as smaller members 304 absorb the turbulent hydraulic forces that are subjected on ball 300 during closing. The speed of the hydraulic forces in, for example, water and wastewater, travel 3,000 to 4,000 feet per second. During a sudden stoppage, the valve ideally needs to close before the hydraulic shock wave travels back in the piping system and pumping equipment. It is therefore important that the ball remain seated once the valve is closed and does not bounce open by leaving the valve seat. The smaller energy members absorb the sudden energy released when the ball reaches the valve seat. This prevents the ball from bouncing off the valve seat and remains seated during normal valve closing.

Although preferred embodiments have been depicted and described in detail herein, it will be apparent to those skilled in the art that various modifications, additions, substitutions and the like can be made without departing from the spirit of the invention and these are therefore considered to be within the scope of the invention as defined in the following claims.

1. A ball check valve comprising:
a housing having walls defining a fluid inlet, a fluid outlet, and a chamber communicating with the inlet and with the outlet, the chamber including a fluid passageway;
a spherical hollow ball in said chamber having a diametric cross-sectional area larger than the area of the inlet, said spherical hollow ball being movable between a first, flow impeding position adjacent the inlet and a second position spaced from the inlet to allow fluid to pass through the valve; and
a plurality of spherical shock absorbing members contained within said spherical hollow ball.

2. The ball check valve of claim 1, wherein the spherical shock absorbing members stabilize the spherical hollow ball while in transition between the first, flow impeding position and the second position.

3. The ball check valve of claim 1, wherein the plurality of spherical shock absorbing members are metallic.

4. The ball check valve of claim 1, wherein said spherical hollow ball is a metallic sphere enclosed by a coat of rubber or synthetic resin.

5. The ball check valve of claim 1, wherein the plurality of spherical shock absorbing members only partially fill said spherical hollow ball.

6. A spherical ball for use in ball check valves, said spherical ball defining a hollow with a plurality of spherical shock absorbing members disposed therein, wherein the plurality of spherical shock absorbing members stabilize the spherical hollow ball during operation of the ball check valve.
